(19) United States
(12) Patent Application Publication
(10) Pub. No.: US 2010/0309282 A1
(43) Pub. Date: Dec. 9, 2010

(54) SYSTEMS AND METHODS FOR PLAYING VIDEO MESSAGES

(75) Inventor: Kin-Hsing Hsieh, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 12/555,057

(22) Filed: Sep. 8, 2009

(30) Foreign Application Priority Data
Jun. 3, 2009 (TW) 98118329

(51) Int. Cl. H04N 7/14

(52) U.S. Cl. 348/14.01; 348/E07.077

(57) ABSTRACT

An exemplary embodiment of a system for playing video messages comprises a caller and a video serving module. The caller sends a request of a communication link to a callee. The callee receives the request of the communication link and establishes the communication link to the caller. The video serving module performs at least one of following steps before the communication link is established, wherein the steps comprise: establishing a first video link to the caller and playing a callee video message corresponding to the callee through the first video link and establishing a second link to the callee and playing a caller video message corresponding to the caller through the second link.

### CROSS REFERENCE TO RELATED APPLICATIONS

This application claims the benefit of Taiwan application Serial No. 098118329 filed Jun. 3, 2009, the subject matter of which is incorporated herein by reference.

### BACKGROUND OF THE INVENTION

1. Field of the Invention

The invention relates to a system and a method for playing video messages, and more particularly to a system and a method for playing video messages before a phone call communication is established.

2. Description of the Related Art

With the development of third generation (3G) mobile phones, video phone communication has become more popular. An instant messaging system in a computer can also perform video phone communication by using a video camera built in the computer.

Additionally, telecommunication value-added services have become more popular, such as providing ring-back tones. After a caller dials a telecommunication number of a callee and before the callee answers the phone to establish a communication link, the caller hears a specific audible sound, such as pop music, sound from a radio etc., and not the traditional dialing tone (toot sounds).

However, telecommunication value-added services providing ring-back tones have limitations. Specifically, telecommunication value-added service providing ring-back tones from an original telephone company to a mobile unit is not continually provided for the mobile unit when the mobile unit communicates with other telephone companies during roaming. Moreover, after a caller dials a telephone number of a callee, only the caller can hear a specific audible sound provided by telecommunication value-added services providing ring-back tones, while the callee still hears the calling bell set by his own phone or the client of an instant messaging system. Thus, it is desired to provide a system and a method for telecommunication value-added services, which improves upon the drawbacks.

### BRIEF SUMMARY OF THE INVENTION

An exemplary embodiment of a system for playing video messages comprises a caller and a video serving module. The caller sends a request of a communication link to a callee. The callee receives the request of the communication link and establishes the communication link to the caller. The video serving module performs at least one of following steps before the communication link is established, wherein steps comprise: establishing a first video link to the caller and playing a callee video message corresponding to the callee through the first video link and establishing a second link to the callee and playing a caller video message corresponding to the caller through the second link.

The video serving module comprises a video database module and an agent module. The video database module stores the callee video message and the caller video message. The agent module establishes the first video link and the second video link, receives the callee video message and the caller video message from the video database module, and plays the callee video message and the caller video message through the first video link and the second video link.

The video serving module comprises a video database module, a first agent module, and a second agent module. The video database module stores the callee video message and the caller video message. The first agent module establishes the first video link, receives the callee video message from the video database module, and plays the callee video message through the first video link. The second agent module establishes the second video link, receives the caller video message from the video data base module, and plays the caller video message through the second video link.

The video serving module comprises a first video database module, a second video data base module, a first agent module, and a second agent module. The first video database module stores the callee video message. The second video data base module stores the caller video message. The first agent module establishes the first video link, receives the callee video message from the first video data base module, and plays the callee video message through the first video link. The second agent module establishes the second video link, receives the caller video message from the second video data base module, and plays the caller video message through the second video link.

In an example of the above embodiment, the first agent module and the callee belong to a first communication network, and the second agent module and the caller belong to a second communication network. The communication link passes through the first and second communication networks.

In another example of the above embodiment, the first agent module and the caller belong to a first communication network, and the second agent module and the callee belong to a second communication network. The communication link passes through the first and second communication networks.

In further another example of the above embodiment, the first agent module and the first video database module belong to a first communication network, and the second agent module and the second video database module belong to a second communication network. The communication link passes through the first and second communication networks.

The system further comprises central office equipment for connecting the communication link between the caller and the callee. The central office equipment comprises at least one of: an intelligent network (IN), a serving GPRS support node (SGSN), a gateway GPRS support node (GGSN), an IP multimedia subsystem (IMS), an S-Gateway of an evolved packet service (EPS), a PDN Gateway of the evolved packet service, a home location register (HLR), a visitor location register (VLR), and a call detail recorder (CDR).

The video database module comprises at least one of: an uploading module for uploading the caller video message from the caller or uploading the callee video message from the callee; a transformation module for transforming a format of the callee video message to a format which can be played by the first video message or transforming a format of the caller video message to a format which can be played by the second video message; a classification module for determining a level of the caller video message or the callee video message, wherein the video database module stops outputting the caller video message when an identity of the callee does not conform to an identity level of the caller video message, or the video database module stops outputting the callee video message when an identity of the caller does not conform to an identity level of the callee video message; a fraud prevention module for recording that contents of the caller video message or the callee video message have been verified, wherein when the contents of the caller video message or the callee video message do not pass a verification test, the video database module stops outputting the caller video message or the callee video message; a selection module, wherein the caller selects the caller video message among the verified video messages by the selection module to the video database module, or the callee selects the callee video message among the verified video messages by the selection module to the video database module; and an editing module, wherein the caller edits the caller video message having a play script through the editing module, or the callee edits the callee video message having a play script through the editing module.

The uploading module further provides a group list of the callee or the caller corresponding to the caller video message or the callee video message, and the agent module plays the caller video message or the callee video message corresponding to the group list according to the group list of the callee or the caller.

The caller video message or the callee video message has a play script. The video serving module determines played contents of the caller video message or the callee video message according to at least one of following variables: an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller.

The caller performs one of following steps of: automatically responding to and accepting the first video link when receiving a request of the first video link from the video serving module; automatically cutting off input of voice signals after accepting the first video link; automatically cutting off the first video link before the communication link between the caller and the callee is established; and recording the callee video message in a dialed call list or a missed call list and replaying the callee video message in the dialed call list or the missed call list according to user requirement of the caller.

The callee performs one of following steps of: automatically responding to and accepting the second video link when receiving a request of the second video link from the video serving module; automatically cutting off input of voice signals after accepting the second video link; automatically cutting off the second video link before the communication link between the caller and the callee is established; and recording the caller video message in an answered call list and replaying the callee video message in the answered call list according to user requirement of the callee.

The agent module comprises at least one of: a cache module for extracting the callee video message or the caller video message from the video database module in advance; a playing module for determining played contents of the callee video message or the caller video message according to at least one of variables and displaying the callee video message or the caller video message through the first video link or the second video link, wherein the variables comprise an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller; a video mixing module for mixing a plurality of video messages to output to the playing module; and a recording module for recording or outputting actual contents which are input to and output from the playing module to external equipment

The plurality of the video messages which are mixed by the video mixing module comprise at least one of the callee video message, the caller video message, an advertisement message, and a third-party video message of a third party. The third party establishes another communication link to the callee or the caller.

An exemplary embodiment of a video serving module is applied in a system to play video messages. The system comprises a caller and a callee. The caller sends a request of a communication link to the callee. The callee receives the request of the communication link and establishes the communication link to the caller. Before the communication link between the caller and the callee is established, the video serving module performs at least one of following steps of establishing a first video link to the caller and playing a callee video message corresponding to the callee through the first video link; and establishing a second link to the callee and playing a caller video message corresponding to the caller through the second video link.

The video serving module comprises a video database module and an agent module. The video database module stores the callee video message and the caller video message. The agent module establishes the first video link and the second video link, receives the callee video message and the caller video message from the video database module, and plays the callee video message and the caller video message through the first video link and the second video link.

The video serving module comprises a video database module, a first agent module, and a second agent module. The video database module stores the callee video message and the caller video message. The first agent module establishes the first video link, receives the callee video message from the video database module, and plays the callee video message through the first video link. The second agent module establishes the second video link, receives the caller video message from the video database module, and plays the caller video message through the second video link.

The video serving module comprises a first video database module, a second video data base module, a first agent module, and a second agent module. The first video database module stores the callee video message. The second video data base module stores the caller video message. The first agent module establishes the first video link, receives the callee video message from the first video data base module, and plays the callee video message through the first video link. The second agent module establishes the second video link, receives the caller video message from the second video data base module, and plays the caller video message through the second video link.

In an example of the above embodiment, the first agent module and the callee belong to a first communication network, and the second agent module and the caller belong to a second communication network. The communication link passes through the first and second communication networks.

In another example of the above embodiment, the first agent module and the caller belong to a first communication network, and the second agent module and the callee belong to a second communication network. The communication link passes through the first and second communication networks.

In further another example of the above embodiment, the first agent module and the first video database module belong to a first communication network, and the second agent module and the second video database module belong to a second communication network. The communication link passes through the first and second communication networks.

The system further comprises central office equipment for connecting the communication link between the caller and the callee and connecting to at least one of the first video link between the video serving module and the caller and the second video link between the video serving module and the callee. The central office equipment comprises at least one of an intelligent network (IN), a serving GPRS support node (SGSN), a gateway GPRS support node (GGSN), an IP multimedia subsystem (IMS), a S-Gateway of an evolved packet service (EPS), a PDN Gateway of the evolved packet service, a home location register (HLR), a visitor location register (VLR), and a call detail recorder (CDR).

The video database module comprises at least one of: an uploading module for uploading the caller video message from the caller or uploading the callee video message from the callee; a transformation module for transforming a format of the callee video message to a format which can be played by the first video message or transforming a format of the caller video message to a format which can be played by the second video message; a classification module for determining a level of the caller video message or the callee video message, wherein the video database module stops outputting the caller video message when an identity of the callee does not conform to an identity level of the caller video message, or the video database module stops outputting the callee video message when an identity of the caller does not conform to an identity level of the callee video message; a fraud prevention module for recording that contents of the caller video message or the callee video message have been verified, wherein when the contents of the caller video message or the callee video message do not pass a verification test, the video database module stops outputting the caller video message or the callee video message; a selection module, wherein the caller selects the caller video message among the verified video messages by the selection module to the video database module, or the callee selects the verified callee video message among verified video messages by the selection module to the video database module; and an editing module, wherein the caller edits the caller video message having a play script through the editing module, or the callee edits the callee video message having a play script through the editing module.

The uploading module further provides a group list of the callee or the caller corresponding to the caller video message or the callee video message, and the agent module plays the caller video message or the callee video message corresponding to the group list according to the group list of the callee or the caller.

The caller video message or the callee video message has a play script. The video serving module determines played contents of the caller video message or the callee video message according to at least one of following variables: an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller.

The agent module comprises at least one of: a cache module for extracting the callee video message or the caller video message from the video database module in advance; a playing module for determining played contents of the callee video message or the caller video message according to at least one of variables and displaying the callee video message or the caller video message through the first video link or the second video link, wherein the variables comprise an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller; a video mixing module for mixing a plurality of video messages to output to the playing module; and a recording module for recording or outputting actual contents which are input to and output from the playing module to external equipment.

The plurality of the video messages which are mixed by the video mixing module comprise at least one of the callee video message, the caller video message, an advertisement message, and a third-party video message of a third party. The third party establishes a communication link to the callee or the caller.

An exemplary embodiment of a method for playing video messages for a system. The system comprises a caller and a callee. The caller sends a request of a communication link to the callee. The callee receives the request of the communication link and establishes the communication link to the caller. Before the communication link between the caller and the callee is established, the method comprises at least one of following steps of: establishing a first video link to the caller and playing a callee video message corresponding to the callee through the first video link; and establishing a second link to the callee and playing a caller video message corresponding to the caller through the second link.

The method may further comprise: uploading the caller video message from the caller; or uploading the callee video message from the callee.

The method may further comprise: transforming a format of the callee video message to a format which can be played by the first video message; or transforming a format of the caller video message to a format which can be played by the second video message.

The method may further comprise: determining a level of the caller video message or the callee video message; stopping outputting the caller video message when an identity of the callee does not conform to an identity level of the caller video message; and stopping outputting the callee video message when an identity of the caller does not conform to an identity level of the callee video message.

The method may further comprise: recording that contents of the caller video message or the callee video message have been verified; and stopping outputting the caller video message or the callee video message when the contents of the caller video message or the callee video message do not pass a verification test.

The method may further comprise: selecting the caller video message among the verified video messages by the caller; or selecting the callee video message among the verified video messages by the callee.

The method may further comprise: editing the caller video message having a play script by the caller; or editing the callee video message having a play script by the callee.

The method may further comprise: providing a group list of the callee or the caller corresponding to the caller video message or the callee video message; and playing the caller video message or the callee video message corresponding to the group list according to the group list of the callee or the caller.

The caller video message or the callee video message has a play script. The method determines played contents of the caller video message or the callee video message according to at least one of following variables: an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller.

The method may further comprise a step of mixing a plurality of video messages to output. The plurality of the video messages comprise at least one of the callee video message, the caller video message, an advertisement message, and a third-party video message of a third party. The third party establishes a communication link to the callee or the caller.

The method may further comprise a step of recording or outputting actual input and output contents to external equipment.

An exemplary embodiment of a user equipment in a system to play video messages is provided. The system comprises a video serving module. The user equipment establishes a video link to the video serving module before a communication link is established between the user equipment and another user equipment in the system. The user equipment plays a video message from the video serving module which corresponds to the other user equipment through the video link.

The video message has a play script. The video serving module determines played contents of the video message according to the following variables: an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller.

The user equipment performs one of following steps of: automatically responding to and accepting the video link when receiving a request of the video link from the video serving module; automatically cutting off input of voice signals after accepting the video link; automatically cutting off the video link before the communication link between the user equipment and the other equipment is established; and recording the video message in a call list and replaying the video message in the call list according to user requirement of the user equipment.

Another exemplary embodiment of a method for playing video messages is provided for user equipment in a system to play video messages. The system comprises a video serving module. The method comprises: establishing a video link to the video serving module before a communication link is established between the user equipment and another user equipment in the system; and playing a video message from the video serving module which corresponds to the other user equipment through the video link.

The video message has a play script. The video serving module determines played contents of the video message according to at least one of following variables: an output of a timer, a dual tone multiple frequency signal of the callee or the caller, a signaling system 7 (SS7) signal of the callee or the caller, a touch gesture signal of the callee or the caller, a voice command of the callee or the caller, a bandwidth of the callee or the caller, and an equipment specification of the callee or the caller.

The method may further comprise: automatically responding to and accepting the video link when receiving a request of the video link from the video serving module; automatically cutting off input of voice signals after accepting the video link; automatically cutting off the video link before the communication link between the user equipment and the other equipment is established; and recording the video message in a call list and replaying the video message in the call list according to user requirement of the user equipment.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A shows an exemplary embodiment of a communication system;

FIG. 1B shows a variation of the embodiment in FIG. 1A;

FIG. 1C shows another variation of the embodiment in FIG. 1A;

FIG. 2 shows another exemplary embodiment of a communication system 200;

FIG. 3A shows another exemplary embodiment of a communication system;

FIG. 3B shows another exemplary embodiment of the communication system 300;

FIG. 3C shows another exemplary embodiment of the communication system 300; and

FIG. 4 shows a flow chart of an exemplary embodiment of a method for playing video messages.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

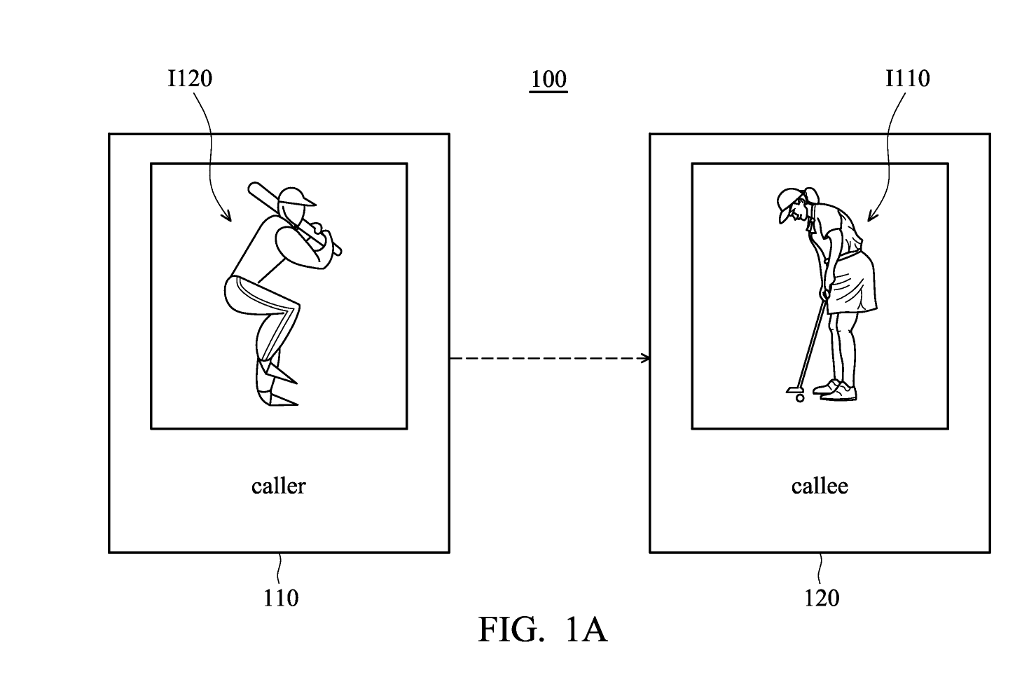

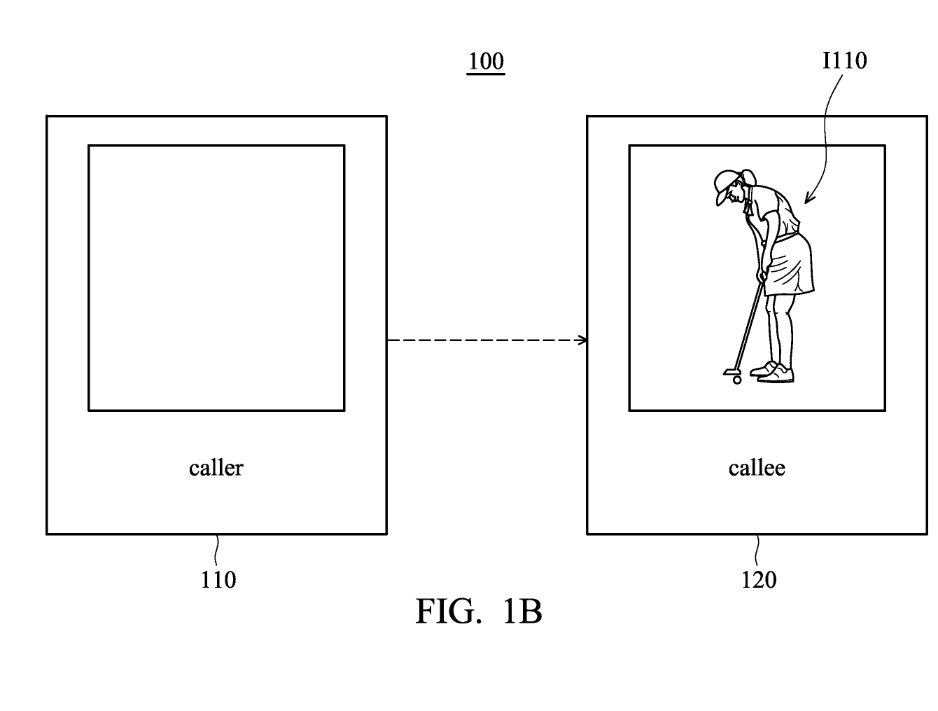

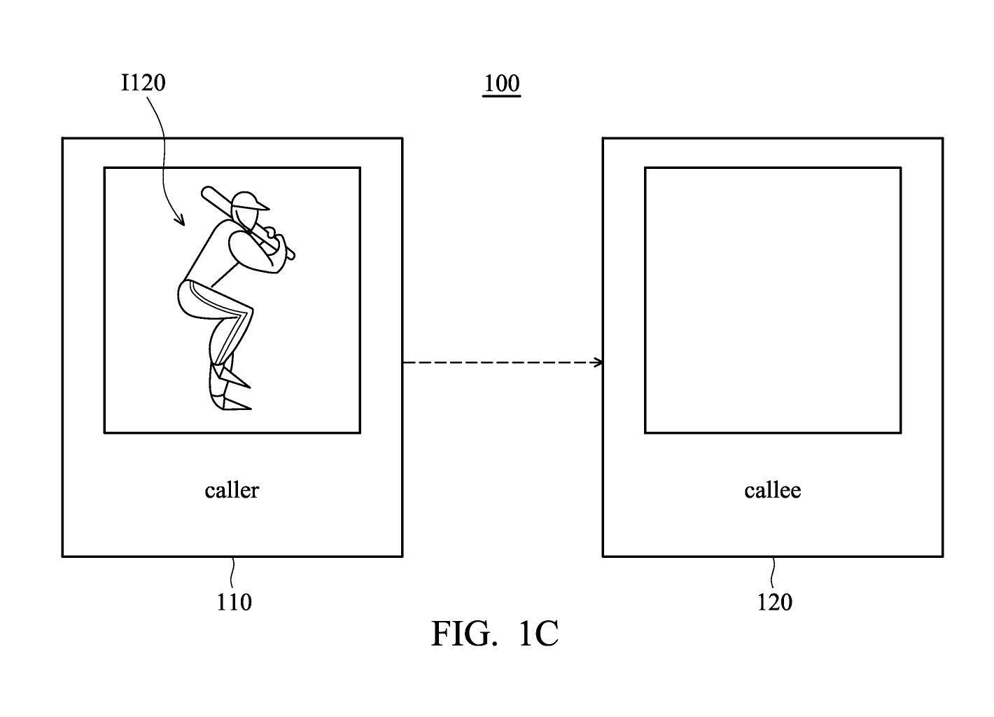

FIG. 1A shows an exemplary embodiment of a communication system. A communication system 100 may be a public service telecommunications network (PSTN), an instant messaging system, a next generation network (NGN), and a third generation (3G) or a future mobile phone system etc. In an embodiment, a communication system which supports a video phone function can be applied as the communication system 100 of FIG. 1A.

The communication system 100 comprises a caller 110 and a callee 120. The caller 110 wants to communicate with the callee 120 by a communication link through an exchange system (not shown in FIG. 1A) of the communication system 100. In the embodiment, the communication link means a virtual exclusive link between the caller 110 and the callee 120 regardless of whether the low-layer transmission method and the exclusive link share the same frequency band, medium, time slice, decoding method, modulation, and etc. The exclusive link can simultaneously transmit messages including dynamic images (anime), static images, audible frequency, signaling, and/or data in one-way or two-ways.

A method performed by the caller 110 to communicate with the callee 120 through the communication link comprises dialing telephone number of the callee 120 via a numeral keyboard or clicking a representative symbol of the callee 120 in the client of an instant messaging system. A communication link which can be established in the communication system 100 can be applied as the communication link of the embodiment.

In the embodiment of FIG. 1A, the caller 110 is a female, while the callee 120 is a male. After the caller 110 completes the initial step to communicate with the callee 120 through the communication link and before the callee 120 performs an answer process (that is before the communications link is completely established), a video message (such as an image I120) which the callee 120 wants to be represented by is played in the caller 110, and a video message (such as an image I110) which the caller 110 wants to be represented by is played in the callee 120.

The video message in the embodiment may include dynamic images, static images, audible frequency, signaling, and/or data which can be transmitted by the exclusive link of the communication system 100, such as a single-tone dual-frequency dialing message. In one embodiment, the video message may further comprise signaling data of the exclusive link, such as the famous signaling system 7 (SS7). If there is not especial indication or exclusion, the video message in the embodiment may include the above dynamic images, static images, audible frequency, signaling, and/or data.

FIG. 1B shows a variation of the embodiment in FIG. 1A. When the callee 120 does not set the video message which can be played in the caller 110, or the callee 120 does not enable the video message service, or the caller 110 does not have enough bandwidth, the caller 110 can not play the video message which represents the callee 120. In the above situations, the callee 120 can still play the video message (the image I110) which represents the caller 110.

FIG. 1C shows another variation of the embodiment in FIG. 1A. Similarly, when the caller 110 does not set the video message which can be played in the callee 120, or the caller 110 does not enable the video message service, or the callee 120 does not have enough bandwidth, the callee 120 can not play the video message which represents the caller 110. In the above situations, the caller 110 can still play the video message (the image I120) which represents the callee 120.

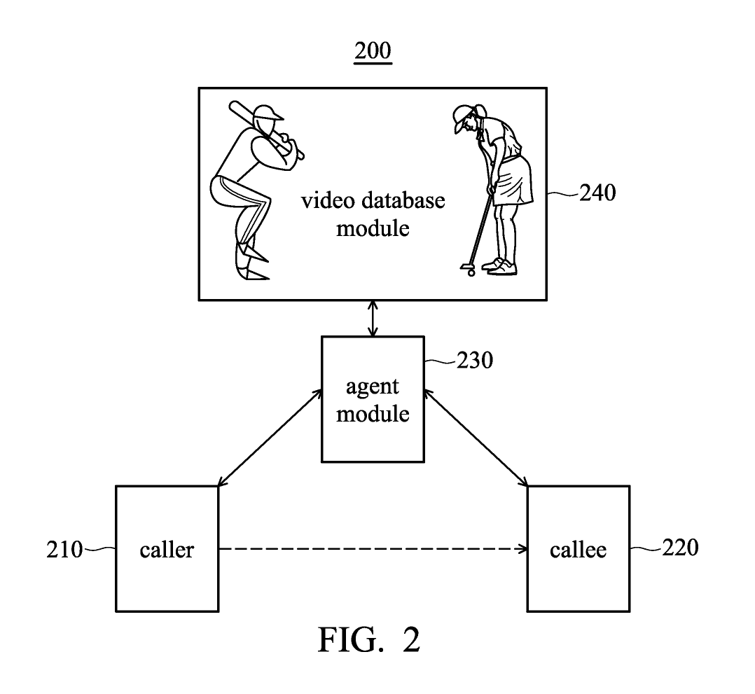

FIG. 2 shows another exemplary embodiment of a communication system 200. A communication system 200 comprises a caller 210, a callee 220, and a video serving module. The caller 210 and the callee 220 of the FIG. 2 are similar to the caller 110 and the callee 220 of the FIG. 1A, respectively. The video serving module of the communication system 200 comprises an agent module 230 and a video database module 240. The video database module 240 is used to store video messages which the caller 210 and the callee 220 want to show to each other. The agent module 230 is used to establish video links respectively with the caller 210 and callee 220 and transmit the video messages stored in the video database module 240 respectively to the caller 210 and the callee 220 before a communication link between the caller 210 and the callee 220 is established.

In one embodiment, the caller 210 and the callee 220 can attach to the same telephone company, and the agent module 230 and the video message database module 240 are a part of the central office equipments or so-called core network of the telephone company. In another embodiment, the agent module 230 and/or the video database module 240 is provided by a fourth entity service provider, not from the telephone company its own. The agent module 230 and/or the video database module 240 is connected to the central office equipments of the telephone company, such as an exchange, a user database, a call detail records database, a service gateway, and/or a packet switch. The fourth entity can provide the video message service of the embodiment by incorporating with the equipments of the telephone company.

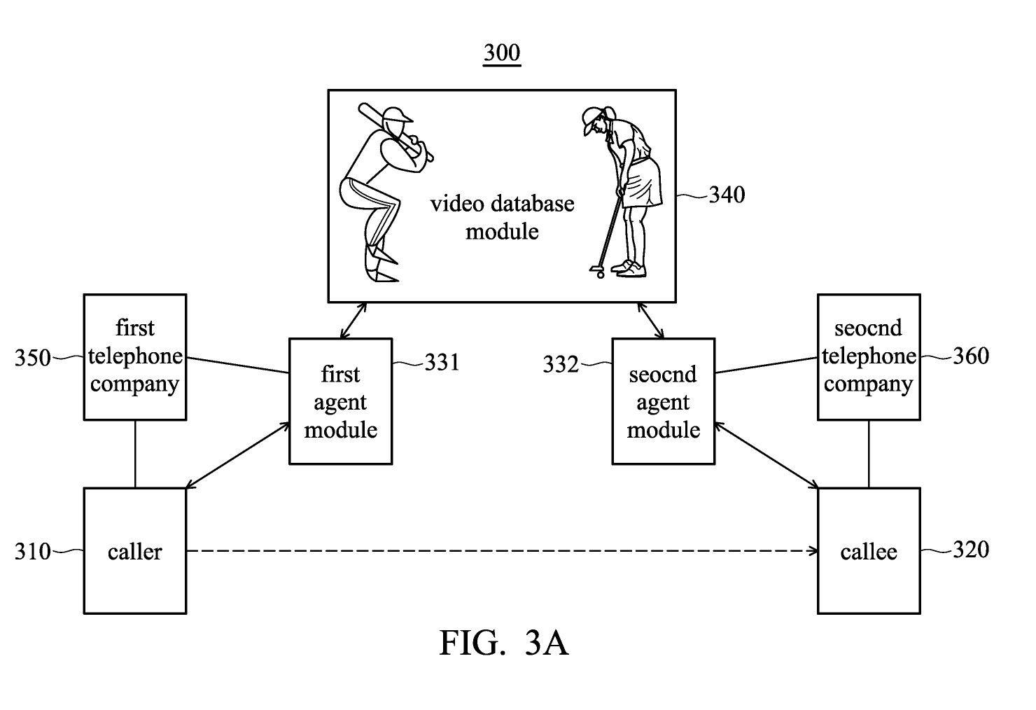

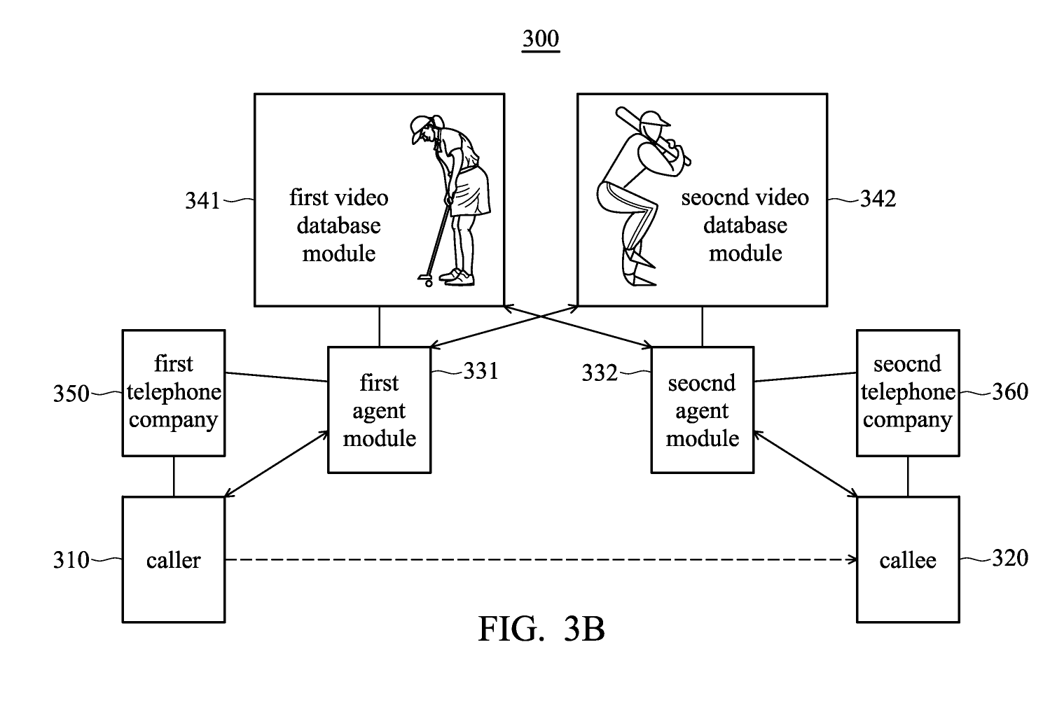

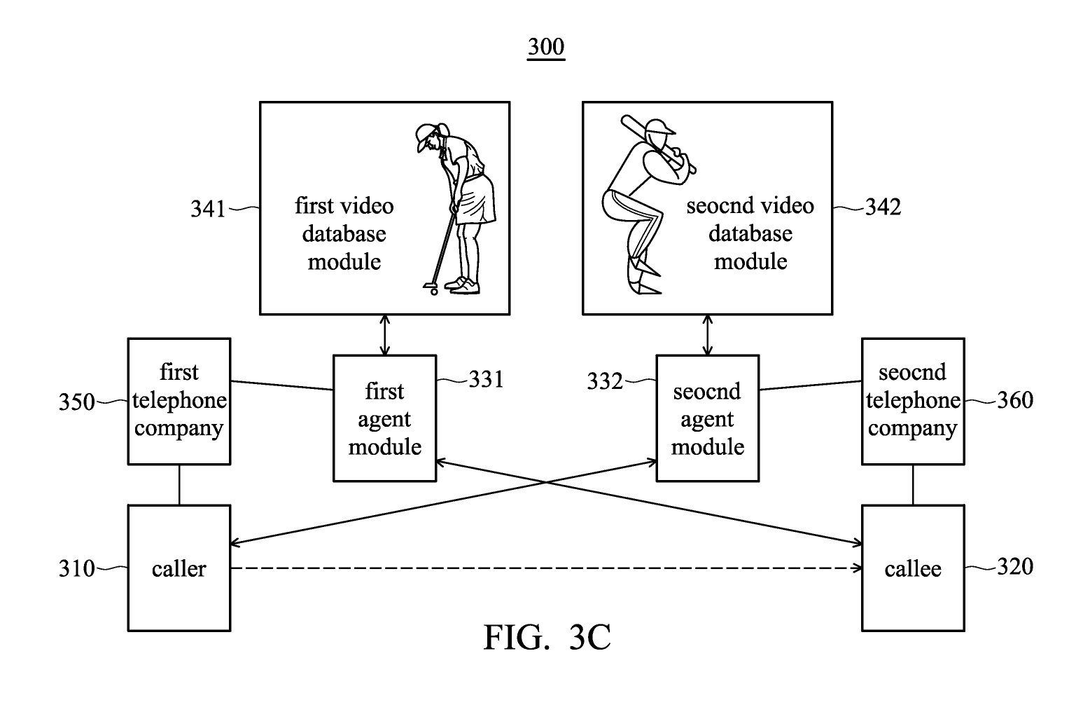

FIG. 3A shows another exemplary embodiment of a communication system. A communication system 300 comprises a caller 310, a callee 320, and a video serving module. The caller 310 and the callee 320 of the FIG. 3 are similar to the caller 110 and the callee 120 of the FIG. 1A, respectively. The communication system 300 comprises communication networks of at least two telephone companies connected to each other, wherein the caller 310 is directly connected to a first telephone company 350, and the callee 320 is directly connected to a second telephone company 360. A communication network of another telephone company may be interconnected between the first telephone company 350 and the second telephone company 360. Any telephone company between the first telephone company 350 and the second telephone company 360 which can support the video phone function can be applied in an example of the embodiment of FIG. 3A.

The video serving module of the communication system 300 comprises a video database module 340 which may be provided by another entity other than the first telephone company 350 or the second telephone company 360. The video database module 340 is used to store video messages which the caller 310 and the callee 320 want to show to each other. In the embodiment of FIG. 3A, the first telephone company 350 is connected to a first agent module 331, and the second telephone company 360 is connected to second agent module 332. The first agent module 331 extracts the video messages which are stored in the video database module 340 by the callee 320. The first agent module 331 establishes a video link to the caller 310 and transmits the video messages, which are stored in the video database module 340 by the callee 320, to the caller 310 before a communication link between the caller 310 and the callee 320 is established. The first agent module 331 serves as the agent of the callee 320. The second agent module 332 extracts the video messages which are stored in the video database module 340 by the caller 310. The first agent module 332 establishes a video link to the callee 320 and transmits the video messages, which are stored in the video database module 340 by the caller 310, to the callee 320 before the communication link between the caller 310 and the callee 320 is established. The second agent module 332 serves as the agent of the caller 310.

FIG. 3B shows another exemplary embodiment of the communication system 300. The communication system 300 comprises a first video database module 341 and a second video database module 342. The first agent module 331 is connected to the first video database module 341, and the second agent module 332 is connected to the second video database module 342.

The first agent module 331 extracts the video messages which are stored in the second video database module 342 by the callee 320. The first agent module 331 establishes a video link to the caller 310 and transmits the video messages which are stored in the second video database module 342 by the callee 320 to the caller 310 before a communication link between the caller 310 and the callee 320 is established. The first agent module 331 serves as the agent of the caller 310. The second agent module 332 extracts the video messages which are stored in the first video database module 341 by the caller 310. The second agent module 332 establishes a video link to the callee 320 and transmits the video messages which are stored in the first video database module 341 by the caller 310 to the callee 320 before the communication link between the caller 310 and the callee 320 is established. The second agent module 332 serves as the agent of the caller 310.

FIG. 3C shows another exemplary embodiment of the communication system 300. Compared with FIGS. 3B and 3C, the communication system 300 in FIG. 3C comprises the same elements as that in FIG. 3B, and, however, the connection relationship between the elements in FIG. 3C is different from that in FIG. 3B.

The first agent module 331 extracts the video messages which are stored in the first video database module 341 by the caller 310. The first agent module 331 establishes a video link to the callee 320 and transmits the video messages which are stored in the first video database module 341 by the caller 310 to the callee 320 before a communication link between the caller 310 and the callee 320 is established. The first agent module 331 serves as the agent of the caller 310. The second agent module 332 extracts the video messages which are stored in the second video database module 342 by the callee 320. The first agent module 332 establishes a video link to the caller 310 and transmits the video messages which are stored in the second video database module 342 by the callee 320 to the caller 310 before the communication link between the caller 310 and the callee 320 is established. The second agent module 332 serves as the agent of the callee 320.

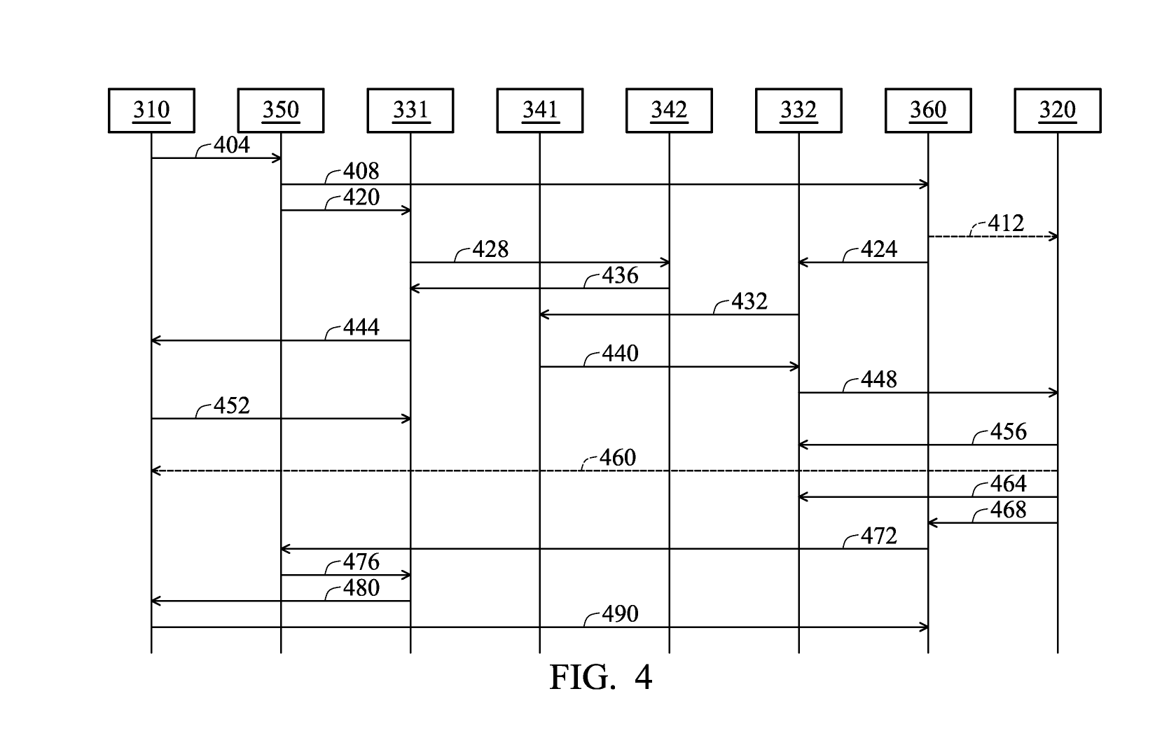

FIG. 4 shows a flow chart of an exemplary embodiment of a method for playing video messages. Refer to the communications system 200 of FIG. 2 or the communications system 300 of FIGS. 3A-3C, for the elements used in the flow chart shown in FIG. 4. For the following description, the communications system 300 of FIG. 3B will be used. Note that for the flow chart in FIG. 4, the sequential and timing order of the steps is not limited. First, in the step 404, the caller 310 dials a telephone number or requests establishment of a communication link to the first telephone company 350 which the caller 310 is connected to. Then, in the step 408, the central office equipment of the first telephone company 350 transmits communication signals to the central office equipment of the second telephone company 360 which the callee 320 is connected to. After receiving the communication signals, the central office equipment of the second telephone company 360 may transmit dialing signals to the callee 320 in the step 412. The callee 320 can notify the user to answer the communication link by the conventional vibration or ringing means.

At the same time when the step 408 is being performed, the central office equipment of the first telephone company 350 sends a video message setting request to the callee agent module 331 in the step 420. In the step 424, after receiving the communication signals, the central office equipment of the second telephone company 360 sends a video message setting request to the caller agent module 332 at the same time when the step 412 is being performed. Ordinary skilled in the art can understand that the steps 408 and 420 can be performed in sequence or in parallel, as well as the steps 412 and 424, due to considerations of implementation.

After receiving the video message setting request, the callee agent module 331 and the caller agent module 332 request to extract the video messages of the callee 320 and the caller 310 from the callee video database module 342 and the caller video database module 341 in the steps 428 and 432, respectively. The caller video database module 342 and the caller video data base module 341 provide the video messages of the callee 320 and the caller 310 to the callee agent module 331 and the caller agent module 332 in the steps 436 and 440, respectively.

After receiving the video messages, the callee agent module 331 and the caller agent module 332 request establishment of video links to the caller 310 and the callee 320 in the steps 444 and 448, respectively. The caller 310 and the callee 320 establish the video links to the callee agent module 331 and the caller agent module 332 in the steps 452 and 456, respectively. Accordingly, the caller 310 and the callee 320 can play the video messages of the callee 320 and the caller 310 which are extracted from the callee agent module 331 and the caller agent module 332.

After the callee 320 answers the communication link in the step 460, the callee 320 can cut off the video link between the callee 320 and the caller agent module 332 in the step 464. Simultaneously, the caller 320 sends signals to pickup the communication link to the central office equipment of the second telephone company 360 in the step 468. After receiving the signals to pickup the communication link, the central office equipment of the second telephone company 360 sends signals to answer the communication link to the central office equipment of the first telephone company 350 in the step 472. After receiving the signals to answer the communication link, the central office equipment of the first telephone company 350 sends a request to cut the video link to the callee agent module 331 in the step 476. After the callee agent module 331 receives the request to cut the video link, the callee agent module 331 cuts off the video link between the caller 310 and the callee agent module 331 in the step 480. In the step 490, the caller 310 and the callee 320 establish the communication link which the caller 310 wants to establish.

In the embodiment, the steps 404, 408, 412, 468, 472, and 490 may comprise normal procedures of conventional communication systems, which are well-known to those ordinary skilled in the art. FIG. 4 shows an exemplary embodiment of operations under normal conditions. Should an abnormal condition occur, such as, that shown in FIGS. 1B and 1C, wherein the caller may not obtain the video link from the callee agent module, or the callee may not obtain the video link from the caller agent module. Specifically, the previous mentioned abnormal condition may occur in any one of the steps 428, 432, 436, and 440, that is the agent modules can not immediately and successfully extract the video messages from the video database modules. The previous mentioned abnormal conditions may also occur in any one of the steps 444, 448, 451, and 456, which the agent modules can not immediately and successfully establish the video links to the caller/callee. One skilled in the art should know that timers can be implemented in each of the elements in the above embodiments. When one element does not obtain the required data or messages in a predetermined time period, the video message service disclosed in the embodiments may be paused, suspended, or interrupted without causing side effect upon the normal dialing process of the communication link. For example, when the user of the callee does not accept the request of the communication link for a determined period of time, the central office equipment of the second telephone company can notify the caller agent module and request that the caller agent module cut off the video link to the callee.

In the above embodiments, the configuration in the central office equipment of the telephone companies can be modified, and the central office equipment can be connected to the agent modules and the video database modules through the modified configuration, such as the interface configuration of an intelligent network (IN), the interface configuration supporting a serving GPRS support node (SGSN) and/or a gateway GRPS support node (GGSN), the interface configuration of IP multimedia subsystem (IMS), the interface configuration of S-Gateway and PDN Gateway of an evolved packet service (EPS) etc. One skilled in the art knows that in the above system, interfaces are available for connection to the agent modules and the video database modules. In other some embodiments, one skilled in the art knows that the expansion space is available to connect to the agent modules and the video database modules in the servers in an instant messaging system and even the clients.

According to the above embodiments, the central office equipment or the central server can annotate the added service field of the user database by data. For example, data for indicating whether a certain user and/or user equipment has the right to use the video message service disclosed in the embodiments or which interface configuration, agent module, and/or video message database is being used. In one embodiment, the user database can be a home location register (HLR) and/or visitor location register (VLR). In other words, before the steps 420 and 424 of FIG. 4 are performed, the central office equipment of the telephone companies can look up the related fields in the user database in advance.

According to the above embodiments, the central office equipment or the central server can count the amount of messages used by the user for the following authentication, authorization, accounting, charging, statistics, and/or reference. In one embodiment, when the agent module transmits the video messages to the user terminal, the agent module can also transmit the version, time, and/or amount of the transmitted messages and other information to a call detail recorder (CDR). For example, the time when the steps 444, 452, 476, and 480 of FIG. 4 occur can be recoded in the CDR. Similarly, the time when the steps 448, 456, 464, and 468 occur can also be recorded in the call detail recorder. Meanwhile, data which can also be recorded in the CDR will be described in the following paragraphs related to the agent modules.

In the above embodiments, the video database module may comprises an uploading module for uploading the video messages which the user wants to show to the other party by the user through an internet interface or a data network provided by the telephone company. The user can group different callers or callees into one group which corresponds to a specific video message. For example, a user can group the phone numbers of a spouse and children into a family group. When one member among the family group calls the user or answers the phone of the user, the video message corresponding to the family group is played. When the person which does not belong to the family group calls the user or answers a phone call from the user, another video message may be played.

The above video database module may comprise a transformation module. When the user uploads the video messages with a different format from the format which is acceptable for the other party which the user would like to communicate with, the transformation module can automatically transforms the format of the uploaded video messages to the format acceptable for the other party. The format transformation can be performed when the video messages are uploaded, or can be dynamically performed on the fly when the video message database module has determined the playing capability of the other party. The later one requires greater capability for real time calculation.

The above video database module may comprise a classification module. When the user uploads the video messages which contains specific contents, the classification module can classify the video messages. For example, the classification module may label the video messages containing alcohol information as being not suitable for children and Muslim. If the other party communicated with the user is one of the two identities, the video database module can avoid playing the video messages.

The above video database module may comprise a fraud prevention module. When the user uploads video messages, the fraud prevention module can verify the uploaded video messages to prevent the user from purposely spreading the video messages which contain fraud information or violate the trademark right and/or copyright.

The above video database module may comprise a selection module. The user can select the video messages which are previously appointed and/or classified to serve as the video messaged which the user wants to transmit to the other party communicated to the user through an internet network or a data network provided by the telephone company.

The above video database module may comprise a cache module. The central office equipment of the telephone company can transmit the video messages of a user belonging to other telephone companies to the cache module. When a communication link is established with the user again, the cache module of the video database module directly transmits the cached video messages to another party communicating with the user. In one embodiment, when the user belonging to other telephone companies roams to the network connected to the video database module of the telephone company, the cache module copies all or a part of the user data from the video database module of the user.

The above video database module may comprise an editing module. With the editing module, the user can edit the video messages through an internet network or a data network provided by the telephone company. For example, at least one section of a video message has a play script. In an example of a video message having a play script, when one party communicating with the user presses the number key “1”, the video message is played in English, and when the party presses the number key “2”, the video message is played in Chinese.

The variables considered by the play script may comprise at least one timer setting, dialing data transmitted by the other party with dual tone multiple frequency signals or information transmitted by the other party with the signaling system 7 (SS7) signaling, gesture signals received by the touch panel of the other party, voice commands of the other party, and background noise. For example, the data representing the number key “1” can be transmitted by the dual tone multiple frequency signals. The playing format or playing version of the play script can be determined according to the bandwidth of the communication links with the other party or specification of the user equipment of the other party. For example, when the bandwidth and the user equipment of the other party meet requirements that support a high definition video link, the play script can be set to comprise high definition video messages.

The above user equipment can serve as a caller and/or a callee. The difference from the conventional user equipment is, in some embodiments, that when the user equipment receives a request of the video link from the agent module, the user equipment can automatically respond to and accept the video link. In other embodiments, according to settings, the user equipment can automatically cut off the input of voice signals after accepting the video link. That is, the user equipment may cut off the microphone input to save transmission bandwidth. In other embodiments, when the user equipment serves as the callee, the user equipment can automatically cut off the video link to the agent module when accepting the communication link. When the user equipment serves as the caller, the user equipment can automatically cut off the video link to the agent module before the communication link between the caller and the callee is established.

The above user equipment may comprise a memory module for storing the video message sent by the other party. The conventional user equipment usually has three communication lists which respectively record answered calls, dialed calls, and missed calls. The communication lists usually list the phone numbers of the other parties and further list the names and representative figures of the other parties, which are stored in the user equipment. If the user equipment does not have the information of the other parties, only the phone numbers may be available. The user may not recognize the names and identities of the other parties. In this situation, for confirmation on identity of the other parties of the phone numbers, the user may need to dial the phone numbers of the other parties, thus wasting time and resources. Accordingly, in embodiments of the invention, the user equipment can corresponds to the communication lists with the video messages stored in the memory module, so that the user can recognize or remember the identities of the other parties by checking the video messages in the communication lists.

The above agent module is used to serve as one party of the video link. However, the number of parties communicated with the agent module by the video link may be one or more than one. In some embodiments, the agent module may serve as a server of video links to a plurality of corresponding parties. For example, in video links to three corresponding parties, the agent module has video messages which were obtained by mixing the video messages of the two parties among the three parties and outputs the mixed video messages to the third party. In one example, the agent module acts as an agent for a party A to communicate with parties B and C by video links. The video phone frame output by the agent module to the party B is obtained by mixing the video messages of the parties A and C, the video phone frame output by the agent module to the party C is obtained by mixing the video messages of the parties A and B, and the video phone frame output by the agent module to the party A is obtained by mixing the video messages of the parties B and C. When there are more video links to more parties, operation of the agent module may be analogous by one skilled in the art from the previous descriptions.

The above agent module may comprise a cache module for extracting video messages from the video database module in advance, particularly video messages having play scripts. When a video message having a play script is being played, a portion of the video message to be played is immediately determined. Thus, the agent module extracts the video message having the play script before the agent module receives a request for playing a portion of the video message.

The above agent module may comprise a playing module for transforming the extracted video messages to the format acceptable for the other party communicating with the user and outputting the transformed video messages. The playing module can extract the video message having a play script. That is, the playing module can accept the variables and immediately output the extracted video messages. In the above example of a video message having a play script, when the other party presses the number key “1”, the video message is played in English, and when the other party presses the number key “2”, the video message is played in Chinese. In some embodiments, the playing module can record the obtained playing flow of the play script and output it to other equipment for usage.

For example, in one example, one bank uses video messages having a play script to activate credit cards. A user can input credit card activating information to a play script of an activating service by pressing keys. The flow of the play script recorded by the playing module is input as the credit card activating information. Credit card server equipment at the bank may then activate the credit card by using the flow of the play script which is output by the agent module. If the user has any problems when using the flow of the play script, the service teller of the bank can contact the user to provide necessary services. Compared with conventional voice services, since the video messages having play script provide visual information, it is easier for users to understand all items at a glance without listening to the long voice statements and memorizing the function keys corresponding the all items

In another embodiment, when the user belonging to one telephone company roams to a network of another telephone company, the user is often not aware of the service contents and/or fees provided by the roamed telecommunications company. Thus, the original telephone company or the roamed telephone company will normally notify the user of the service contents and/or fees through messages. However, the user may be required to call the telephone companies to enable or disable certain services. Thus, if telephone companies can provide services with play script according to the invention, information concerning service contents and/or fees and enabling or disabling of service contents of the roamed telephone company may be more conveniently and speedily provided to users.

According to the above embodiments, the playing module may comprise a video mixing module to mix at least two video messages into one frame. For example, a frame of a picture-in-picture (PIP) comprises two video messages. The audio signals of the main picture of the frame are output, and the input of the user equipment is transmitted to the agent module corresponding to the main picture. For example, the video mixing module can provide functions of adding scrolling messages to the main picture, adding symbols at the corners of the frame, or adding watermarks.

In some embodiments, when the first party is establishing a communication link to the second party and receives a communication request from the third party, the agent module can mix the messages transmitted from the second party and the third party together by the video mixing module and transmit the mixed messages to the user. In other embodiments, when the the first party and the second party are transmitting video messages to each other and the first party receives a communication request from a third party, the agent module can mix the messages transmitted from the second party and the third party together by the video mixing module and transmit the mixed messages to the first party regardless of whether the first party is a caller or callee. In other words, in the embodiments, the central office equipment of the telephone company can switch the original communication link to connect to the agent module, and the video mixing module of the agent module can mix the original messages and subsequent messages together and transmit the mixed messages to the user.

In addition to mixing the above messages and/or communication link contents, the video mixing module can also mix static advertisements, a portion of an advertisement video, or scrolling messages with the original video messages. Certainly, the user can decide that advertisements (referred to additional information which is not in the original video messages) are played in the original messages or not.

Generally speaking, a caller may be not easily defrauded by the contents of the video messages set by a callee communicated with the caller. That is because that the caller voluntarily calls the callee, and the caller is mentally prepared to determine whether the contents of the video messages from the callee are true and false before receiving the video messages. On the contrary, a callee may be easily defrauded by the contents of the video messages set by a caller communicated with the callee. That is because that the callee passively receives the video messages from the caller, and the callee is not mentally prepared to determine whether the contents of the video messages from the caller are true and false before receiving the video messages. In any one of the above two situations, fraud induced from the false contents of the video messages may cause a criminal problem. Thus, the above agent module may comprise a recording module. The recording module transmits and/or copies the actual contents of the video messages from and to the user at real time for the law enforcement agencies to serve as monitoring data and/or evidence collection of a law court.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for playing video messages comprising:
a caller for sending a request of a communication link to a callee, wherein the callee receives the request of the communication link and establishes the communication link to the caller; and
a video serving module for performing at least one of following steps before the communication link is established, wherein the steps comprise:
establishing a first video link to the caller and playing a callee video message corresponding to the callee through the first video link; and
establishing a second link to the callee and playing a caller video message corresponding to the caller through the second link.

2. The system as claimed in claim 1, wherein the video serving module comprises:
a video database module for storing the callee video message and the caller video message; and
an agent module for establishing the first video link and the second video link, receiving the callee video message and the caller video message from the video database module, and playing the callee video message and the caller video message through the first video link and the second video link.

3. The system as claimed in claim 1, wherein the video serving module comprises:
a video database module for storing the callee video message and the caller video message;
a first agent module for establishing the first video link, receiving the callee video message from the video database module, and playing the callee video message through the first video link; and
a second agent module for establishing the second video link, receiving the caller video message from the video data base module, and playing the caller video message through the second video link.

4. The system as claimed in claim 1, wherein the video serving module comprises:
a first video database module for storing the callee video message;
a second video data base module for storing the caller video message;
a first agent module for establishing the first video link, receiving the callee video message from the first video data base module, and playing the callee video message through the first video link; and
a second agent module for establishing the second video link, receiving the caller video message from the second video data base module, and playing the caller video message through the second video link.

5. The system as claimed in claim 1 further comprises central office equipment for connecting the communication link between the caller and the callee and connecting to at least one of:
the first video link between the video serving module and the caller; and
the second video link between the video serving module and the callee;
wherein the central office equipment comprises at least one of:
an intelligent network (IN);
a serving GPRS support node (SGSN);
a gateway GPRS support node (GGSN);
an IP multimedia subsystem (IMS);
an S-Gateway of an evolved packet service (EPS);
a PDN Gateway of the evolved packet service;
a home location register (HLR);
a visitor location register (VLR); and
a call detail recorder (CDR).

6. The system as claimed in claim 2, wherein the video message database module comprises at least one of:
an uploading module for uploading the caller video message from the caller or uploading the callee video message from the callee;
a transformation module for transforming a format of the callee video message to a format which can be played by the first video message or transforming a format of the caller video message to a format which can be played by the second video message;
a classification module for determining a level of the caller video message or the callee video message, wherein the video database module stops outputting the caller video message when an identity of the callee does not conform to an identity level of the caller video message, or the video database module stops outputting the callee video message when an identity of the caller does not conform to an identity level of the callee video message;
a fraud prevention module for recording that contents of the caller video message or the callee video message have been verified, wherein when the contents of the caller video message or the callee video message do not pass a verification test, the video database module stops outputting the caller video message or the callee video message;
a selection module, wherein the caller selects the caller video message among the verified video messages by the selection module to the video database module, or the callee selects the callee video message among the verified video messages by the selection module to the video database module; and
an editing module, wherein the caller edits the caller video message having a play script through the editing module, or the callee edits the callee video message having a play script through the editing module.

7. The system as claimed in claim 6, wherein the uploading module further provides a group list of the callee or the caller corresponding to the caller video message or the callee video message, and the agent module plays the caller video message or the callee video message corresponding to the group list according to the group list of the callee or the caller.

8. The system as claimed in one of claims 1, wherein the caller video message or the callee video message has a play script, and the video serving module determines played contents of the caller video message or the callee video message according to at least one of following variables:
an output of a timer;
a dual tone multiple frequency signal of the callee or the caller;
a signaling system 7 (SS7) signal of the callee or the caller;
a touch gesture signal of the callee or the caller;
a voice command of the callee or the caller;
a bandwidth of the callee or the caller; and
an equipment specification of the callee or the caller.

9. The system as claimed in one of claims 1, wherein the caller performs at least one of following steps of:
automatically responding to and accepting the first video link when receiving a request of the first video link from the video serving module;
automatically cutting off input of voice signals after accepting the first video link;
automatically cutting off the first video link before the communication link between the caller and the callee is established; and
recording the callee video message in a dialed call list or a missed call list and replaying the callee video message in the dialed call list or the missed call list according to user requirement of the caller; and
wherein the callee performs at least one of following steps of:
automatically responding to and accepting the second video link when receiving a request of the second video link from the video serving module;
automatically cutting off input of voice signals after accepting the second video link;
automatically cutting off the second video link before the communication link between the caller and the callee is established; and
recording the caller video message in an answered call list and replaying the callee video message in the answered call list according to user requirement of the callee.

10. The system as claimed in claim 2, wherein the agent module comprises at least one of:
a cache module for extracting the callee video message or the caller video message from the video database module in advance;
a playing module for determining played contents of the callee video message or the caller video message according to at least one of variables and displaying the callee video message or the caller video message through the first video link or the second video link, wherein the variables comprise:
an output of a timer;
a dual tone multiple frequency signal of the callee or the caller;
a signaling system 7 (SS7) signal of the callee or the caller;
a touch gesture signal of the callee or the caller;
a voice command of the callee or the caller;
a bandwidth of the callee or the caller; and
an equipment specification of the callee or the caller;
a video mixing module for mixing a plurality of video messages to output to the playing module; and
a recording module for recording or outputting actual contents which are input to and output from the playing module to external equipment.

11. The system as claimed in claim 10, wherein the plurality of the video messages which are mixed by the video mixing module comprise at least one of:
the callee video message;
the caller video message;
an advertisement message; and
a third-party video message of a third party, wherein the third party establishes a communication link to the callee or the caller.

12. A video serving module for a system to play video messages, wherein the system comprises a caller and a callee, the caller sends a request of a communication link to the callee, the callee receives the request of the communication link and establishes the communication link to the caller, and before the communication link between the caller and the callee is established, the video serving module performs at least one of following steps of:
establishing a first video link to the caller and playing a callee video message corresponding to the callee through the first video link; and
establishing a second link to the callee and playing a caller video message corresponding to the caller through the second video link.

13. The video serving module as claimed in claim 12 comprising:
a video database module for storing the callee video message and the caller video message; and
an agent module for establishing the first video link and the second video link, receiving the callee video message and the caller video message from the video database module, and playing the callee video message and the caller video message through the first video link and the second video link.

14. The video serving module as claimed in claim 12 comprising:
a video database module for storing the callee video message and the caller video message;
a first agent module for establishing the first video link, receiving the callee video message from the video database module, and playing the callee video message through the first video link; and
a second agent module for establishing the second video link, receiving the caller video message from the video database module, and playing the caller video message through the second video link.

15. The video serving module as claimed in claim 12 comprising:
a first video database module for storing the callee video message;
a second video data base module for storing the caller video message;
a first agent module for establishing the first video link, receiving the callee video message from the first video data base module, and playing the callee video message through the first video link; and
a second agent module for establishing the second video link, receiving the caller video message from the second video data base module, and playing the caller video message through the second video link.

16. The video serving module as claimed in claim 12, wherein the system further comprises central office equipment for connecting the communication link between the caller and the callee and connecting to at least one of:
the first video link between the video serving module and the caller; and
the second video link between the video serving module and the callee;
wherein the central office equipment comprises at least one of:
an intelligent network (IN);
serving GPRS support node (SGSN);
a gateway GPRS support node (GGSN);
an IP multimedia subsystem (IMS);
an S-Gateway of an evolved packet service (EPS);
a PDN Gateway of the evolved packet service;
a home location register (HLR);
a visitor location register (VLR); and
a call detail recorder (CDR).

17. The video serving module as claimed in claim 13, wherein the video database module comprises at least one of:
an uploading module for uploading the caller video message from the caller or uploading the callee video message from the callee;
a transformation module for transforming a format of the callee video message to a format which can be played by the first video message or transforming a format of the caller video message to a format which can be played by the second video message;
a classification module for determining a level of the caller video message or the callee video message, wherein the video database module stops outputting the caller video message when an identity of the callee does not conform to an identity level of the caller video message, or the video database module stops outputting the callee video message when an identity of the caller does not conform to an identity level of the callee video message;
a fraud prevention module for recording that contents of the caller video message or the callee video message have been verified, wherein when the contents of the caller video message or the callee video message do not pass a verification test, the video database module stops outputting the caller video message or the callee video message;
a selection module, wherein the caller selects the caller video message among verified video messages by the selection module to the video database module, or the callee selects the verified callee video message among the verified video messages by the selection module; and
an editing module, wherein the caller edits the caller video message having a play script through the editing module, or the callee edits the callee video message having a play script through the editing module.

18. The video serving module as claimed in claim 17, wherein the uploading module further provides a group list of the callee or the caller corresponding to the caller video message or the callee video message, and the agent module plays the caller video message or the callee video message corresponding to the group list according to the group list of the callee or the caller.

19. The video serving module as claimed in one of claims 12, wherein the caller video message or the callee video message has a play script, and the video serving module determines played contents of the caller video message or the callee video message according to at least one of following variables:
an output of a timer;
a dual tone multiple frequency signal of the callee or the caller;
a signaling system 7 (SS7) signal of the callee or the caller;
a touch gesture signal of the callee or the caller;
a voice command of the callee or the caller;
a bandwidth of the callee or the caller; and
an equipment specification of the callee or the caller.

20. The video serving module as claimed in claim 13, wherein the agent module comprises at least one of:
a cache module for extracting the callee video message or the caller video message from the video database module in advance;
a playing module for determining played contents of the callee video message or the caller video message according to at least one of variables and displaying the callee video message or the caller video message through the first video link or the second video link, wherein the variables comprise:
an output of a timer;
a dual tone multiple frequency signal of the callee or the caller;
a signaling system 7 (SS7) signal of the callee or the caller;
a touch gesture signal of the callee or the caller;
a voice command of the callee or the caller;
a bandwidth of the callee or the caller; and
an equipment specification of the callee or the caller;
a video mixing module for mixing a plurality of video messages to output to the playing module; and
a recording module for recording or outputting actual contents which are input to and output from the playing module to external equipment;
wherein the plurality of the video messages which are mixed by the video mixing module comprise at least one of:
the callee video message;
the caller video message;
an advertisement message; and
a third-party video message of a third party, wherein the third party establishes a communication link to the callee or the caller.

21. A method for playing video messages for a system, wherein the system comprises a caller and a callee, the caller sends a request of a communication link to the callee, the callee receives the request of the communication link and establishes the communication link to the caller, and before the communication link between the caller and the callee is established, the method comprises at least one of following steps of:
establishing a first video link to the caller and playing a callee video message corresponding to the callee through the first video link; and
establishing a second link to the callee and playing a caller video message corresponding to the caller through the second link.

22. A user equipment in a system to play video messages, wherein the system comprises a video serving module, the user equipment establishes a video link to the video serving module before a communication link is established between the user equipment and another user equipment in the system, and the user equipment plays a video message from the video serving module which corresponds to the other user equipment through the video link.

23. The user equipment as claimed in claim 22, wherein the video message has a play script, and the video serving module determines played contents of the video message according to at least one of following variables:
an output of a timer;
a dual tone multiple frequency signal of the callee or the caller;
a signaling system 7 (SS7) signal of the callee or the caller;
a touch gesture signal of the callee or the caller;
a voice command of the callee or the caller;
a bandwidth of the callee or the caller; and
an equipment specification of the callee or the caller.

24. The user equipment as claimed in claim 22 performing one of following steps of:
automatically responding to and accepting the video link when receiving a request of the video link from the video serving module;
automatically cutting off input of voice signals after accepting the video link;
automatically cutting off the video link before the communication link between the user equipment and the other equipment is established; and
recording the video message in a call list and replaying the video message in the call list according to user requirement of the user equipment.

25. A method for playing video messages for user equipment in a system to play video messages, wherein the system comprises a video serving module, and the method comprises:
establishing a video link to the video serving module before a communication link is established between the user equipment and another user equipment in the system; and
playing a video message from the video serving module which corresponds to the other user equipment through the video link.

26. The method as claimed in claim 25 further comprising at least one of the following steps:
automatically responding to and accepting the video link when receiving a request of the video link from the video serving module;
automatically cutting off input of voice signals after accepting the video link;
automatically cutting off the video link before the communication link between the user equipment and the other equipment is established; and
recording the video message in a call list and replaying the video message in the call list according to user requirement of the user equipment.
